(19) United States
(12) Patent Application Publication
(10) Pub. No.: US 2008/0156374 A1
(43) Pub. Date: Jul. 3, 2008

(54) BREATHER DEVICE

(75) Inventors: Masato Nakano, Toyota-shi (JP); Masaru Morise, Nukata-gun (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/964,850

(22) Filed: Dec. 27, 2007

(30) Foreign Application Priority Data
Dec. 28, 2006 (JP) 2006-354831

(51) Int. Cl. F16K 1/32

(52) U.S. Cl. 137/14

(57) ABSTRACT

A breather device includes: a breather path with a first end open to the atmosphere and a second end in communication with the inside of a housing; and a valve mechanism that blocks the first end of the breather path when the water pressure of water flowing toward the breather path acts on the valve mechanism, but that otherwise leaves the first end of the breather path open.

### INCORPORATION BY REFERENCE

The disclosure of Japanese Patent Application No. 2006-354831 filed on Dec. 28, 2006 including the specification, drawings and abstract is incorporated herein by reference in its entirety.

### BACKGROUND OF THE INVENTION

1. Field of the Invention

The invention relates to a breather device that regulates the internal pressure of a housing.

2. Description of the Related Art

A case for hermetically enclosing a component of an automobile such as a transmission or a differential mechanism, for example, is provided with a breather device for regulating the internal pressure of the case. The breather device is provided with a ventilation flow path (breather path) allowing communication between the interior of the case and the outside such as the atmosphere. When the pressure inside the case is higher than the pressure outside, the air inside the case is discharged via the ventilation flow path. As a result, the internal pressure of the case is regulated so as to restrict an increase in the internal pressure of the case.

Japanese Patent Application Publication No. 8-285053 (JP-A-8-285053) discloses a breather device including a breather plug main body mounted, for example, to a transmission case, and a cap attached to the breather plug main body to prevent entry of water or other foreign matter from outside. Specifically, this breather device is constructed as follows. A metal breather plug main body has a ventilation hole drilled in its center, and a small diameter portion in its upper part. A synthetic resin engagement hook is mounted on the small diameter portion. A synthetic resin cap with its upper end closed is placed on top of the engagement hook. An engagement hole formed in a lower part of the cap is engaged with the engagement hook to attach the cap on top of the breather plug main body. A packing for closing the ventilation hole of the breather plug main body and a coil spring are accommodated inside the cap.

With the cap placed on top, this breather device prevents entry of water or other foreign matter from outside into the case. When the internal pressure of the case exceeds a threshold level, the packing is pushed up against the coil spring to open the ventilation hole of the breather plug main body, allowing the air inside the case to be discharged outside.

In the breather device described above, however, when the air is not being discharged, the packing is in tight contact with a packing receiving portion at the upper end of the breather plug main body by the elastic force of the coil spring, and therefore the ventilation hole is closed. The breather device thus has the structure of a check valve allowing one-way communication and prohibiting air intake. Therefore, the resistance against air discharge is large, and the case and an oil seal may be damaged due to repetitive changes in the internal pressure of the case.

In contrast, a different structure of the breather device is also possible, in which the interior and the exterior of the case are also in communication when the air is not being discharged. With such a structure, however, water may enter into the case in the presence of a water flow in the direction of entering into the breather path, such as a high-pressure water flow used during a carwash, for example. Thus, in this case, measures are required to prevent entry of water into the case.

### SUMMARY OF THE INVENTION

The invention provides a breather device that prevents changes in the internal pressure of a housing, and that prevents entry of water into the housing.

A first aspect of the invention provides a breather device that regulates the internal pressure of a housing, including: a breather path with a first end that is open to the atmosphere and a second end that is in communication with the interior of a housing; and a valve mechanism configured to block the first end of the breather path when the water pressure of water flowing toward the breather path acts on the valve mechanism, but that otherwise leaves the first end of the breather path open.

According to the breather device of the above aspect, it is possible to prevent changes in the internal pressure of the housing, and to maintain the internal pressure at atmospheric pressure. When there is water flowing toward the breather path, entry of water into the housing is prevented. In addition, it is possible to avoid an increase in the resistance against air discharge, and to avoid damaging the housing and its oil seal due to changes in the internal pressure of the housing.

The valve mechanism may have an opening on its top side, and may be attached to an outer periphery of a tubular member forming the breather path so as to be movable along an extending direction of the tubular member.

The valve mechanism may have a projection on its bottom side that blocks the first end of the breather path with the projection when the valve mechanism is pushed by the water pressure of water flowing toward the breather path.

The valve mechanism may be coupled to a case main body that forms a part of the breather path via a rotary shaft.

The valve mechanism may have a projection on its upper side that blocks the first end of the breather path with the projection when the valve mechanism is pivoted by the water pressure of water flowing toward the breather path.

The valve mechanism may be provided inside a casing connected to a tubular member that forms the breather path so as to be movable along an extending direction of the casing.

The casing may include a first casing that forms a part of the breather path, and a second casing that accommodates the valve mechanism. A plurality of hooks may be provided in a lower part of the second casing to regulate movement of the valve mechanism.

The valve mechanism may have a projection on its top side that blocks the first end of the first casing when the valve mechanism is pushed by the water pressure of water flowing toward the breather path.

The valve mechanism may have an opening that is open to the atmosphere, and the opening may be positioned below the first end of the breather path As a result, even if water enters into the breather path and the valve mechanism, it is possible to immediately discharge the water to the outside via the opening. In addition, it is possible to prevent the water from remaining inside the breather path and the valve mechanism.

A portion of the breather path may extend upward from the first end. In this way, the volume corresponding to the head difference from the first end of the breather path to the highest position of the portion on the first end side serves as a buffer with a buffer volume before water enters into the housing. As a result, even if water enters into the breather path from the first end of the breather path, it is possible to prevent entry of the water into the housing, as long as the amount of the water is not more than the buffer volume.

The portion of the breather path may extend vertically upward from the first end to a predetermined height.

The housing may accommodate a transmission mechanism, a differential mechanism, or a transfer mechanism of an automobile.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view showing a breather device in accordance with a first embodiment of the invention;

FIG. 2 is a sectional view of the breather device of FIG. 1 showing the state where a valve mechanism is opened;

FIG. 3 is a sectional view of the breather device of FIG. 1 showing the state where the valve mechanism is closed;

FIG. 4 is a perspective view showing a breather device in accordance with a second embodiment of the invention;

FIG. 5 is a sectional view of the breather device of FIG. 4 showing the state where a valve mechanism is opened;

FIG. 6 is a sectional view of the breather device of FIG. 4 showing the state where the valve mechanism is closed;

FIG. 7 is a perspective view showing a breather device in accordance with a third embodiment of the invention;

FIG. 8 is a bottom view of the breather device of FIG. 7;

FIG. 9 is a sectional view of the breather device of FIG. 7 showing the state where a valve mechanism is opened; and

FIG. 10 is a sectional view of the breather device of FIG. 7 showing the state where the valve mechanism is closed.

### DETAILED DESCRIPTION OF EMBODIMENTS

A description will hereinafter be made of embodiments of the invention with reference to the accompanying drawings.

A breather device of the invention is attached to a transmission case CS that accommodates a component of a transmission of an automobile, for example, to regulate the internal pressure of the transmission case CS. Specifically, the breather device of the invention includes: a breather path with a first end open to the atmosphere and a second end in communication with the inside of the transmission case CS with the breather device attached to the transmission case CS; and a valve mechanism configured to block the first end of the breather path when the water pressure of water flowing toward the breather path acts on the valve mechanism, but that otherwise leaves the first end of the breather path open.

The following describes the first to the third embodiment of the breather device that is attached to the transmission case CS.

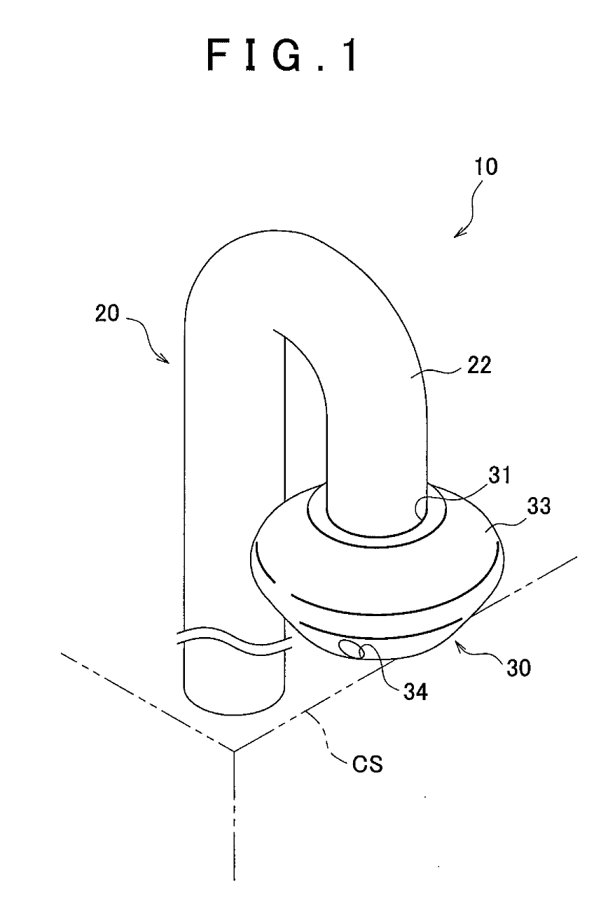

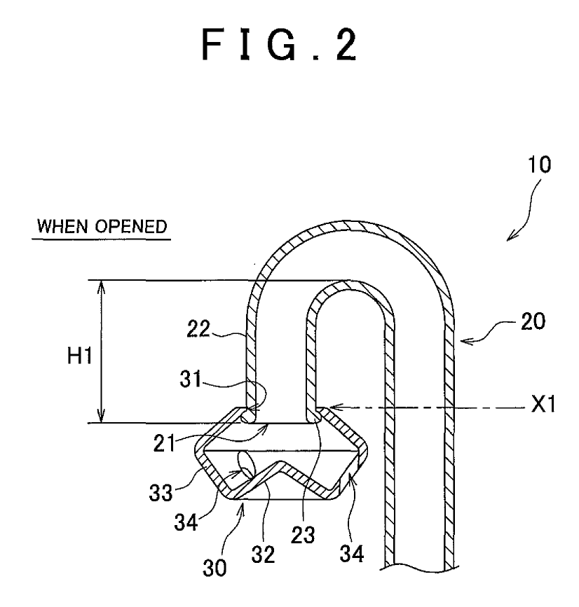

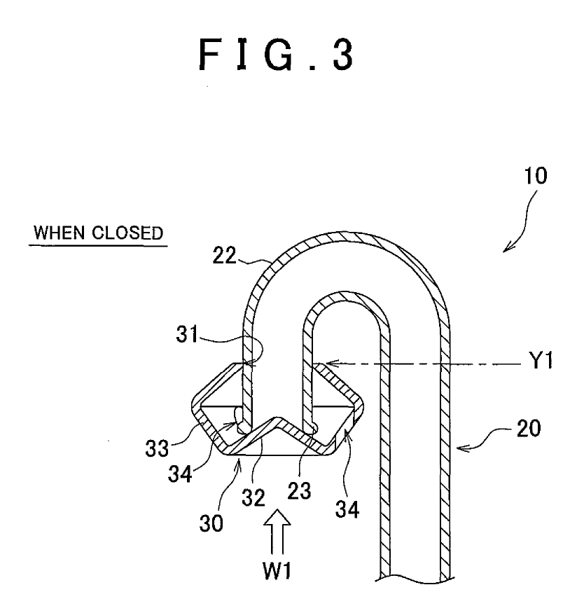

FIG. 1 is a perspective view showing a breather device in accordance with the first embodiment. FIG. 2 is a sectional view of the breather device of FIG. 1 when the valve mechanism is open. FIG. 3 is a sectional view of the breather device of FIG. 1 when the valve mechanism is closed.

As shown in FIGS. 1 to 3, a breather device 10 of the first embodiment includes a hose 20 and a cover 30.

The hose 20 is connected to a transmission case CS. A first end of the hose 20 is provided with an inlet/outlet port 21, and open to the atmosphere. A second end of the hose 20 extends to the transmission case CS, and is in communication with the interior of the transmission case CS. The inlet/outlet port 21 at the first end of the hose 20 is open downward. Here, the flow path for ventilation from the transmission case CS to the inlet/outlet port 21, in other words, the internal space of the hose 20, may correspond to the “breather path” of the invention.

A portion 22 of the hose 20 on the first end side (that is, on the inlet/outlet port 21 side) extends vertically upward from the inlet/outlet port 21. In the first embodiment, the portion 22 extends upward from the inlet/outlet port 21 to a height H1. A stopper 23 is provided at the outer periphery of the inlet/outlet port 21 of the hose 20 to prevent the cover 30 from slipping off.

The cover 30 is attached at the first end of the hose 20 to cover the inlet/outlet port 21 of the hose 20. The cover 30 has an attachment port 31 opening on its top side for attachment to the hose 20. The inner diameter of the attachment port 31 is substantially equal to the outer diameter of the hose 20, and smaller than the outer diameter of the stopper 23 of the hose 20. Therefore, the cover 30 is movable in the extending direction of the hose 20, that is, in the vertical direction (between X1 and Y1, for example) in the case of the first embodiment. In the absence of a water flow W1 to be described later, the uppermost end of the cover 30 is moved to the lowermost position X1 (that is, the position where the breather path is opened) by the force of gravity, with the stopper 23 preventing the cover 30 from slipping off from the hose 20.

A projection 32 formed on the bottom side of the cover 30 to block the inlet/outlet port 21 of the hose 20, in the presence of a water flow W1 to be described later, utilizing the water pressure. The projection 32 is shaped to block the inlet/outlet port 21 of the hose 20. In the first embodiment, the projection 32 has a conical shape projecting inward (upward) from the bottom of the cover 30.

The cover 30 is hollow, and its intermediate part 33 is swelled outward at the middle in the vertical direction. At least one ventilation hole 34 is formed in the intermediate part 33. In the first embodiment, three ventilation holes 34 are provided at predetermined intervals in the circumferential direction. The ventilation holes 34 are formed in positions below the inlet/outlet port 21 of the hose 20 in the absence of a water flow W1 to be described later.

The operation of the cover 30 will be described. The cover 30 corresponds to the “valve mechanism” of the invention that blocks the inlet/outlet port 21 of the hose 20 when the breather path is blocked, and that opens the inlet/outlet port 21 when the breather path is opened, as described below.

In the absence of a water flow W1 in the direction of entering into the breather path from the inlet/outlet port 21 of the hose 20 (water flow from below), the cover 30 is in the lowermost position X1 due to the force of gravity, as shown in FIG. 2. At this time, the projection 32 of the cover 30 as a valve element is separated from the periphery of the inlet/outlet port 21 of the hose 20 as a valve seat, opening the inlet/outlet port 21 of the hose 20. As a result, the interior of the transmission case CS is in communication with the atmosphere via the hose 20.

With the breather path is open, when the internal pressure of the transmission case CS exceeds the external pressure (atmospheric pressure), the air inside the transmission case CS is discharged outside via the inlet/outlet port 21 of the hose 20 and the ventilation holes 34 of the cover 30. On the other hand, when the internal pressure of the transmission case CS is lower than the atmospheric pressure, the outside air is taken into the transmission case CS via the ventilation holes 34 of the cover 30 and the inlet/outlet port 21 of the hose 20.

Thus, it is possible to prevent changes in the internal pressure of the transmission case CS, and to maintain the internal pressure at atmospheric pressure. As a result, it is possible to avoid increases in the resistance against air discharge, and to avoid damaging the transmission case CS and its oil seal due to changes in the internal pressure of the transmission case CS.

On the other hand, in the presence of a water flow W1 in the direction of entering into the breather path from the inlet/outlet port 21 of the hose 20, such as a high-pressure water flow used during a carwash, for example, the cover 30 is pushed up by the water pressure to move upward from the lowermost position X1, as shown in FIG. 3. When the cover 30 moves to the uppermost position Y1 (that is, the position where the breather path is blocked), the distal end of the projection 32 of the cover 30 as a valve element enters into the inlet/outlet port 21 of the hose 20 so that the projection 32 comes into contact with the periphery of the inlet/outlet port 21 as a valve seat. As a result, the inlet/outlet port 21 of the hose 20 is blocked by the projection 32, isolating the interior of the transmission case CS from the atmosphere.

With the breather path blocked, the entry of water into the transmission case CS is prevented. Here, in the first embodiment, the water flow W1 comes from below. In the case of a water flow from a direction other than below, the intermediate portion 33 of the cover 30 prevents entry of water into the transmission case CS.

When the water flow W1 from below stops, the water pressure does not act on the cover 30 any more, and therefore the cover 30 falls due to the force of gravity from the uppermost position Y1 to the lowermost position X1. As a result, the interior of the transmission case CS is again in communication with the atmosphere via the hose 20.

As described above, according to the breather device 10 of the first embodiment, it is possible to maintain the internal pressure of the transmission case CS at atmospheric pressure when the breather path is opened, and to prevent entry of water into the transmission case CS when the breather path is blocked.

The portion 22 of the hose 20 on the first end side extends upward from the inlet/outlet port 21, and the volume corresponding to the difference from the inlet/outlet port 21 of the hose 20 to the highest position of the portion 22 in the vertical direction (the height H1) serves as a buffer with a buffer volume before water enters into the transmission case CS. Therefore, even if water enters into the hose 20 from the inlet/outlet port 21, it is possible to prevent entry of the water into the transmission case CS, as long as the amount of the water is not more than the buffer volume.

When the water flow W1 from below stops, the water that has entered into the hose 20 from the inlet/outlet port 21 is discharged through the ventilation holes 34 of the cover 30. Here, since the ventilation holes 34 are positioned below the inlet/outlet port 21 of the hose 20 when the breather path is open, it is possible to immediately discharge the water that has entered into the hose 20 and the cover 30 to the outside via the ventilation holes 34. As a result, it is possible to prevent the water from remaining inside the hose 20 and the cover 30.

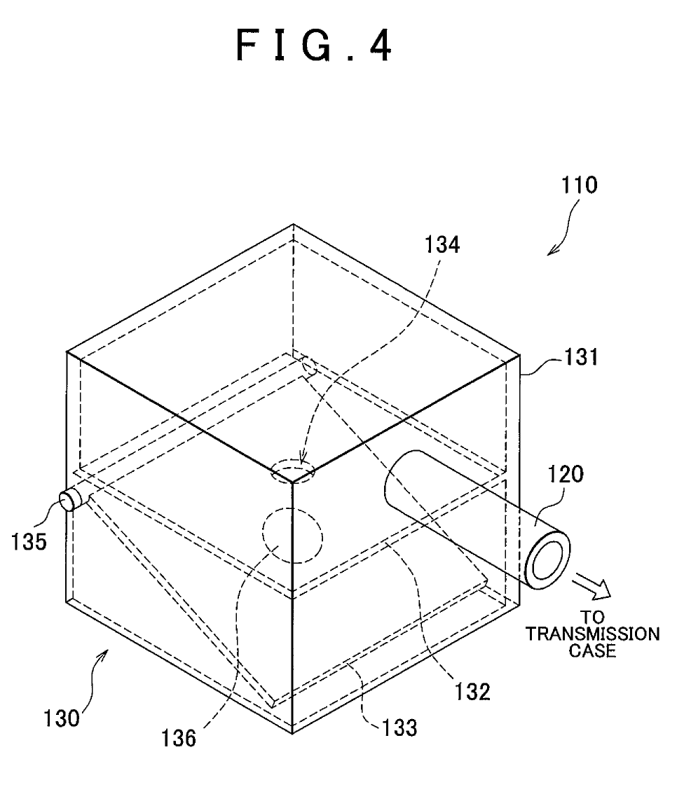

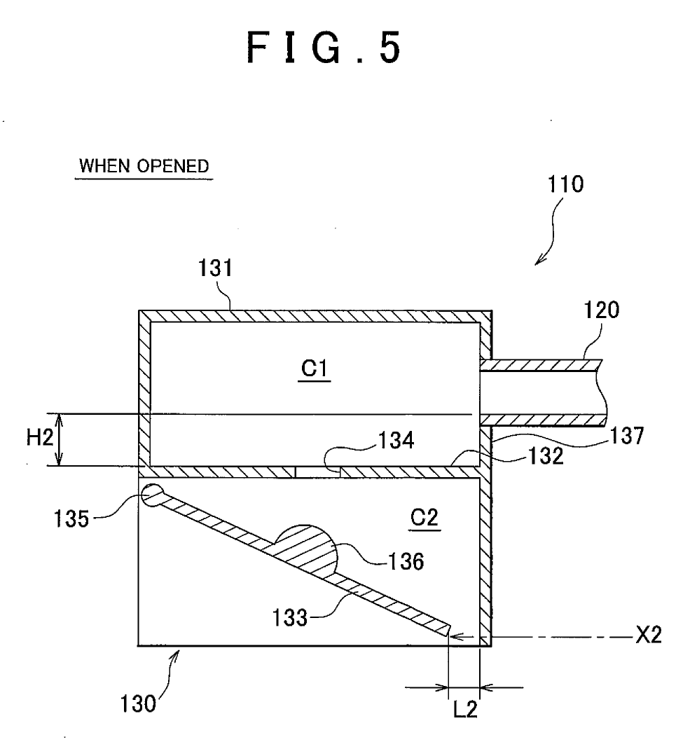

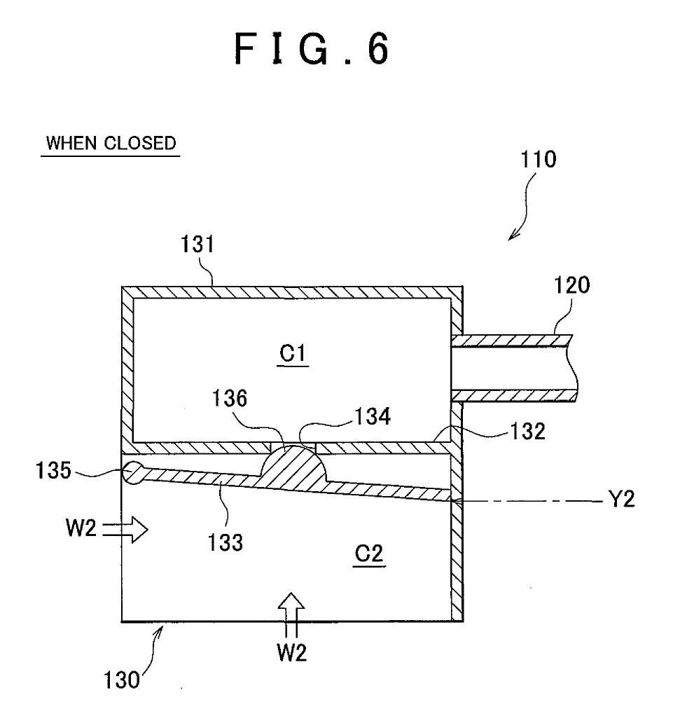

FIG. 4 is a perspective view showing a breather device in accordance with the second embodiment of the invention. FIG. 5 is a sectional view of the breather device of FIG. 4 showing the state where the valve mechanism is opened. FIG. 6 is a sectional view of the breather device of FIG. 4 showing the state where the valve mechanism is closed.

As shown in FIGS. 4 to 6, a breather device 110 of the second embodiment includes a hose 120 and a casing 130.

The hose 120 is connected to a transmission case CS and the casing 130. A first end of the hose 120 extends to the casing 130, and is in communication with the inside of the casing 130. A second end of the hose 120 extends to the transmission case CS, and is in communication with the inside of the transmission case CS. In FIG. 4, the transmission case CS is not shown, and only a part of the hose 120 on the first end side is shown.

The casing 130 includes a main body 131 in the shape of a box which is open downward, and a rectangular partition plate 132 and a rectangular movable plate 133 provided inside the main body 131.

The partition plate 132 is integrally provided at the middle, in the vertical direction, inside the main body 131. The partition plate 132 partitions the inside of the main body 131 into upper and lower spaces C1 and C2. The space C1 in the main body 131 above the partition plate 132 is in communication with the first end of the hose 120. The space C2 in the main body 131 below the partition plate 132 is open to the atmosphere on the bottom and left sides.

A circular inlet/outlet port 134 is formed substantially in the center of the partition plate 132. The upper and lower spaces C1 and C2 in the main body 131 are in communication with each other via the inlet/outlet port 134. In other words, the upper space C1 in the main body 131 is open to the atmosphere via the inlet/outlet port 134. The flow path for ventilation from the transmission case CS to the inlet/outlet port 134, specifically, the internal space of the hose 120 and the space C1, corresponds to the “breather path” of the invention.

A portion 137 of the main body 131 where the hose 120 is connected is positioned above the inlet/outlet port 134. In the second embodiment, the portion 137 is positioned above the inlet/outlet port 134 by a height H2.

The movable plate 133 has substantially the same size as the partition plate 132, and is provided under the partition plate 132. The movable plate 133 is coupled to the main body 131 via a rotary shaft 135 provided at one side (the left side in the drawing). The other three sides of the rectangular movable plate 133 are not coupled to the main body 131. Therefore, the movable plate 133 is rotatable about the rotary shaft 135. The space under the rotary shaft 135 is open, with no left wall of the main body 131 provided under the rotary shaft 135.

In the absence of a water flow W2 to be described later, the movable plate 133 is rotated and kept to the lowermost position X2 (that is, the position where the breather path is opened) by the force of gravity. In the second embodiment, the movable plate 133 is substantially horizontal to be in the uppermost position Y2 (that is, the position where the breather path is blocked) (FIG. 6), and rotated clockwise therefrom by appropriately 30 degrees to be in the lowermost position X2. In the latter position, a stopper may be provided to keep the movable plate 133 to the lowermost position X2.

When the movable plate 133 is in the lowermost position X2, there is a gap L2 between one side of the movable plate 133 (the right side in the drawing) and the wall surface of the main body 131. On the other hand, there is substantially no gap between the other three sides of the movable plate 133 and the wall surface of the main body 131. The gap L2 becomes smaller as the movable plate 133 rotates counterclockwise from the lowermost position X2, and becomes substantially “zero” when the movable plate 133 reaches the uppermost position Y2.

The movable plate 133 has a projection 136 formed substantially in the center of its top to block the inlet/outlet port 134 of the partition plate 132, in the presence of a water flow W2 to be described later, utilizing the water pressure. The projection 136 has a shape that can block the inlet/outlet port 134 of the partition plate 132. In the second embodiment, the projection 136 has a semispherical shape projecting upward from the top of the movable plate 133.

The operation of the movable plate 133 provided in the casing 130 will be described. The movable plate 133 corresponds to the “valve mechanism” of the invention that blocks the inlet/outlet port 134 of the partition plate 132 when the breather path is blocked, and that opens the inlet/outlet port 134 when the breather path is open, as described below.

In the absence of a water flow W2 in the direction of entering into the breather path from the inlet/outlet port 134 of the partition plate of the casing 130 (a water flow from below or the left), the movable plate 133 is in the lowermost position X2 due to the force of gravity, as shown in FIG. 5. At this time, the projection 136 of the movable plate 133 as a valve element is separated from the periphery of the inlet/outlet port 134 of the partition plate 132 as a valve seat, opening the inlet/outlet port 134. As a result, the interior of the transmission case CS is communicated with the atmosphere via the hose 120 and the upper space C2 in the casing 130.

With the breather path opened, when the internal pressure of the transmission case CS exceeds the external pressure (atmospheric pressure), the air inside the transmission case CS is discharged outside via the inlet/outlet port 134 of the partition plate 132 of the casing 130 and the gap L2. On the other hand, when the internal pressure of the transmission case CS becomes lower than the atmospheric pressure, the air outside is taken into the transmission case CS via the gap L2 and the inlet/outlet port 134 of the partition plate 132 of the casing 130.

Thus, it is possible to prevent changes in the internal pressure of the transmission case CS, and to keep the internal pressure to the atmospheric pressure. As a result, it is possible to avoid an increase in the resistance against air discharge, and to avoid damage to the transmission case CS and its oil seal due to changes in the internal pressure of the transmission case CS.

In contrast, in the presence of a water flow W2 in the direction of entering into the breather path from the inlet/outlet port 134 of the partition plate 132 of the casing 130, such as a high-pressure water flow used during a carwash, for example, the movable plate 133 is rotated counterclockwise by the water pressure, upward from the lowermost position X2, as shown in FIG. 6. When the movable plate 133 is rotated to the uppermost position Y2 to become substantially horizontal, the distal end of the projection 136 of the movable plate 133 as a valve element enters into the inlet/outlet port 134 of the partition plate 132 so that the projection 136 comes into contact with the periphery of the inlet/outlet port 134 as a valve seat. As a result, the inlet/outlet port 134 is blocked by the projection 136, isolating the interior of the transmission case CS from the atmosphere.

With the breather path blocked, it is possible to prevent entry of water into the transmission case CS. Here, in the second embodiment, the water flow W2 comes from below or the left. In the case of a water flow from a direction other than below or the left, the wall surface of the main body 131 prevents entry of water into the transmission case CS.

When the water flow W2 from below or the left stops, the water pressure does not act on the movable plate 133 any more, and therefore the movable plate 133 is rotated clockwise by the force of gravity from the uppermost position Y2 to the lowermost position X2. As a result, the interior of the transmission case CS is again communicated with the atmosphere via the hose 120 and the upper space C2 in the casing 130.

As described above, according to the breather device 110 of the second embodiment, it is possible to maintain the internal pressure of the transmission case CS at atmospheric pressure when the breather path is opened, and to prevent entry of water into the transmission case CS when the breather path is blocked.

The portion 137 of the main body 131 where the hose 120 is connected is configured to extend upward from the inlet/outlet port 134 of the partition plate 132, and the volume corresponding to the head difference from the inlet/outlet port 134 to the highest position of the portion 137 in the vertical direction (the height H2) serves as a buffer with a buffer volume before water enters into the transmission case CS. As a result, even if water enters into the main body 131 from the inlet/outlet port 134 of the partition plate 132, it is possible to prevent entry of the water into the transmission case CS, as long as the amount of the water is not more than the above buffer volume.

When the water flow W2 from below or the left stops, the water having entered into the main body 131 from the inlet/outlet port 134 is discharged outside from the gap L2 of the casing 130. Here, since the gap L2 of the casing 130 is positioned below the inlet/outlet port 134 when the breather path is opened, it is possible to immediately discharge the water that has entered into the main body 131 to the outside via the gap L2. As a result, it is possible to prevent the water from remaining in the main body 131.

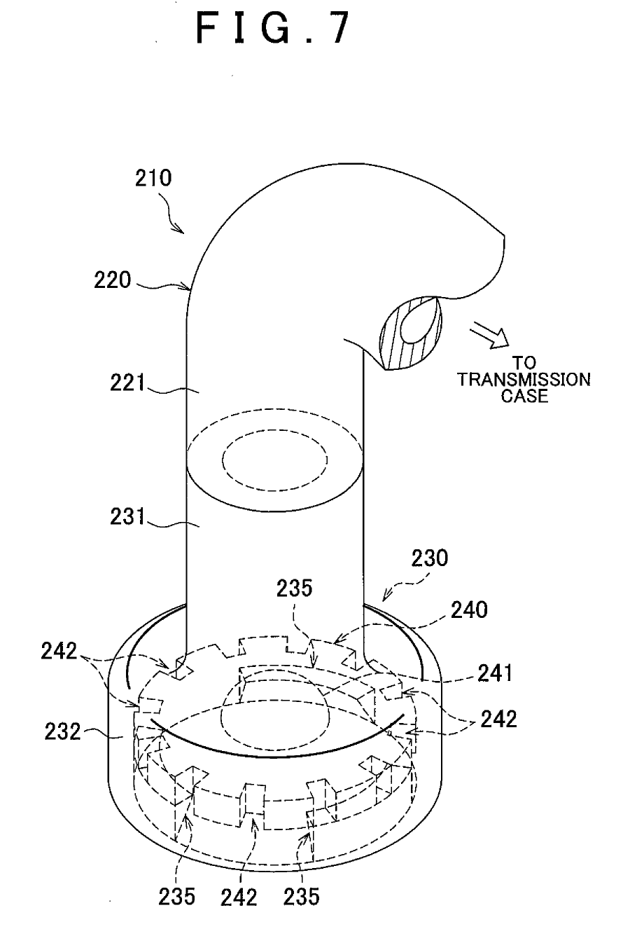

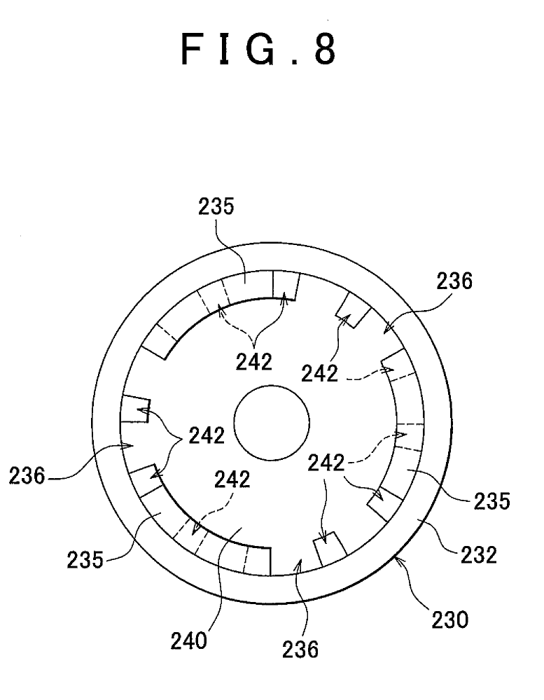

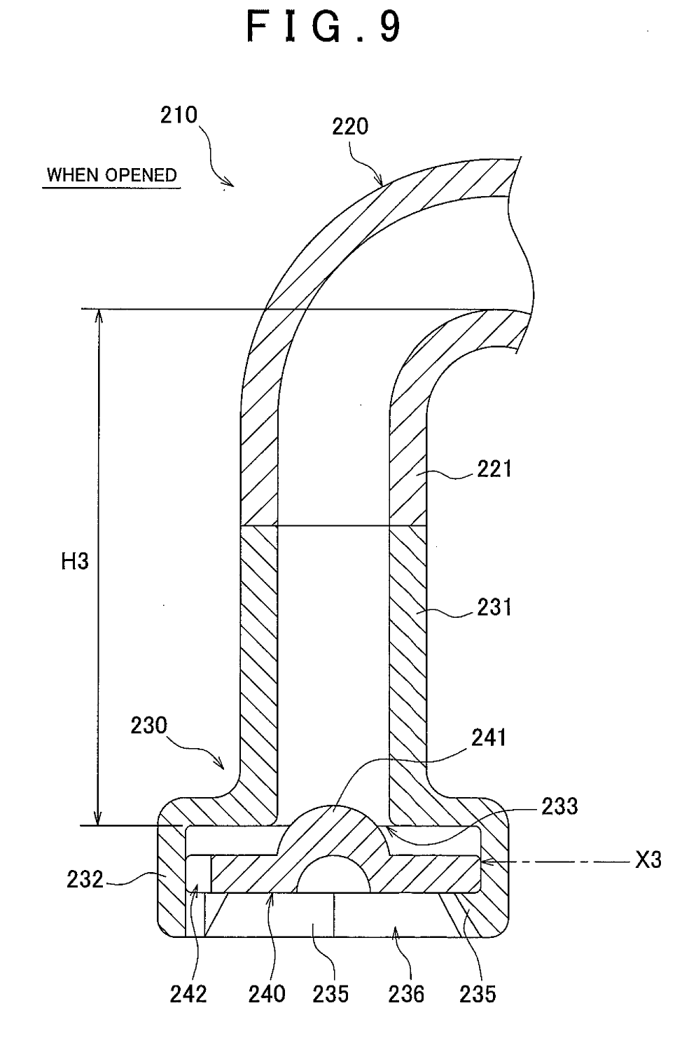

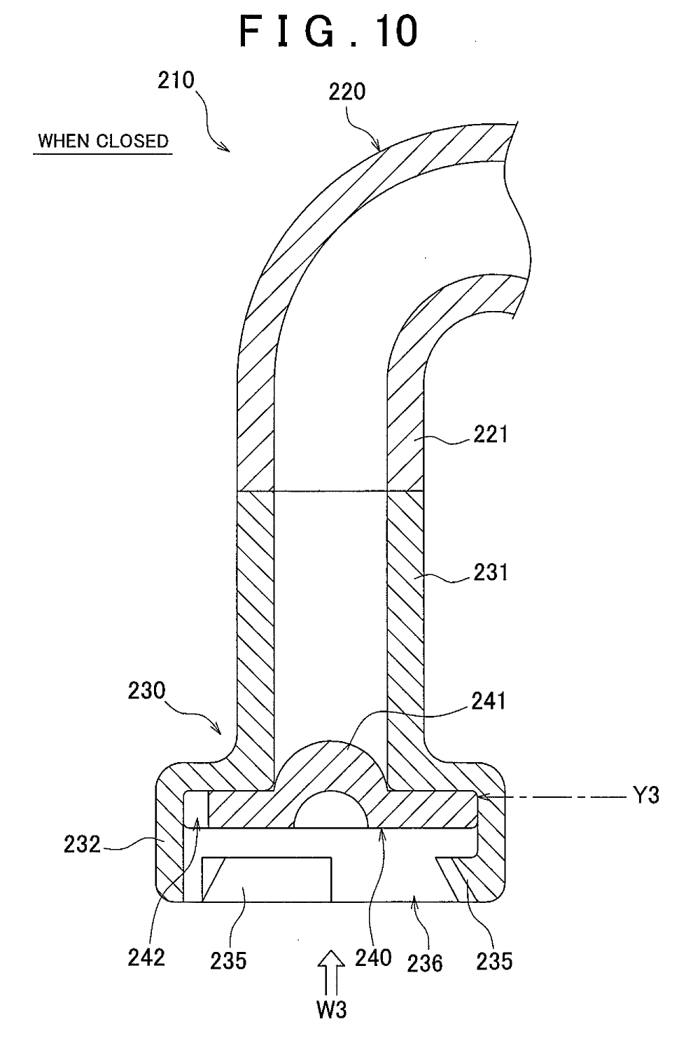

FIG. 7 is a perspective view showing a breather device in accordance with the third embodiment of the invention. FIG. 8 is a bottom view of the breather device of FIG. 7. FIG. 9 is a sectional view showing the breather device of FIG. 7 when the a valve mechanism is opened. FIG. 10 is a sectional view showing the breather device of FIG. 7 when the valve mechanism is closed.

As shown in FIGS. 7 to 10, a breather device 210 of the third embodiment includes a hose 220, a casing 230, and a movable plate 240.

The hose 220 is connected to a transmission case CS and the casing 230. A first end of the hose 220 extends to the casing 230, and is in communication with the interior of the casing 130. A second end of the hose 220 extends to the transmission case CS, and is in communication with the interior of the transmission case CS. In FIG. 7, the transmission case CS is not shown, and only a part of the hose 220 on the first end side is shown.

The casing 230 includes a first casing 231 provided in its upper part and having a cylindrical shape with a smaller diameter, and a second casing 232 provided in its lower part and having a cylindrical shape with a larger diameter. The first casing 231 and the second casing 232 both extend along the vertical direction, and are provided coaxially with each other.

A first end of the first casing 231 is provided with an inlet/outlet port 233, and open to the atmosphere. The inlet/outlet port 233 is provided at the connection between the first casing 231 and the second casing 232 of the casing 230. A second end of the first casing 231 is connected to a first end of the hose 220. The flow path for ventilation from the transmission case CS to the inlet/outlet port 233, specifically, the internal space of the hose 220 and the internal space of the first casing 231, corresponds to the “breather path” of the invention.

A portion 221 of the hose 220 on the first end side (that is, on the casing 230 side) extends vertically upward. In the third embodiment, the portion 221 extends upward from the inlet/outlet port 233 of the casing 230 to a height H3.

The movable plate 240 has a substantially disk shape, and is provided below the inlet/outlet port 233 inside the casing 230. Specifically, the movable plate 240 is provided inside the second casing 232. The outer diameter of the movable plate 240 is substantially equal to the inner diameter of the second casing 232. The movable plate 240 is provided inside the second casing 232 so as to be movable in the vertical direction. In the absence of a water flow W3 to be described later, the movable plate 240 is in the lowermost position X3 (that is, the position where the breather path is opened) due to its own weight. A plurality of hooks 235 projecting inward are provided in a lower part of the second casing 232 to prevent the movable plate 240 from slipping off from the casing 230.

The movable plate 240 has a projection 241 formed substantially in the center of its top to block the inlet/outlet port 233 of the casing 230, in the presence of a water flow W3 to be described later, utilizing the water pressure. The projection 241 has a shape that can block the inlet/outlet port 233 of the casing 230. In the third embodiment, the projection 241 has a semispherical shape projecting upward from the top of the movable plate 240.

The lower end of the second casing 232 is open. The hooks 235 described above are formed to extend inward at the periphery of the lower part of the second casing 232. In the third embodiment, three hooks 235 are provided at predetermined intervals in the circumferential direction. A notch 236 is provided between the adjacent hooks 235. Thus, three hooks 235 and three notches are provided alternately at the periphery of the lower part of the second casing 232.

On the other hand, a plurality of ventilation holes 242 are formed at the periphery of the movable plate 240. In the third embodiment, twelve ventilation holes 242 are provided at predetermined intervals in the circumferential direction. Here, the ventilation holes 242 at the periphery of the movable plate 240 are positioned above the hooks 235 or the notches 236 at the periphery of the lower part of the second casing 232 such that at least one ventilation hole 242 is positioned above any one of the notches 236. In other words, at least one ventilation hole 242 and any one of notches 236 overlap each other in the vertical direction. The inside and the outside of the second casing 232 of the casing 230 are in communication with each other via the ventilation hole 242 and the notch 236 overlapping each other in the vertical direction.

The operation of the movable plate 240 provided inside the casing 230 will be described. The movable plate 240 corresponds to the “valve mechanism” of the invention that blocks the inlet/outlet port 233 of the casing 230 when the breather path is blocked, and that opens the inlet/outlet port 233 when the breather path is opened, as described below.

In the absence of a water flow W3 in the direction of entering into the breather path from the inlet/outlet port 233 of the casing 230 (a water flow from below), the movable plate 240 is in the lowermost position X3 due to the force of the gravity, as shown in FIG. 9. At this time, the projection 241 of the movable plate 240 as a valve element is separated from the periphery of the inlet/outlet port 233 of the casing 230 as a valve seat, opening the inlet/outlet port 233. As a result, the interior of the transmission case CS is communicated with the atmosphere via the hose 220 and the casing 230.

With the breather path opened, when the internal pressure of the transmission case CS exceeds the external pressure (atmospheric pressure), the air inside the transmission case CS is discharged outside via the inlet/outlet port 233 of the casing 230, the ventilation holes 242 of the movable plate 240, and the notches 236 of the second casing 232 of the casing 230. On the other hand, when the internal pressure of the transmission case CS becomes lower than the atmospheric pressure, the air outside is taken into the transmission case CS via the notches 236 of the second casing 232 of the casing 230, the ventilation holes 242 of the movable plate 240, and the inlet/outlet port 233 of the casing 230.

Thus, it is possible to prevent changes in the internal pressure of the transmission case CS, and to keep the internal pressure to the atmospheric pressure. As a result, it is possible to avoid an increase in the resistance against air discharge, and to avoid damage to the transmission case CS and its oil seal due to changes in the internal pressure of the transmission case CS.

In contrast, in the presence of a water flow W3 in the direction of entering into the breather path from the inlet/outlet port 233 of the casing 230, such as a high-pressure water flow used during a carwash, for example, the movable plate 240 is pushed up by the water pressure to move upward from the lowermost position X3, as shown in FIG. 10. When the movable plate 240 moves to the uppermost position Y3, the projection 241 of the movable plate 240 as a valve element enters into the inlet/outlet port 233 of the casing 230 so that the projection 241 comes into contact with the periphery of the inlet/outlet port 233 as a valve seat. As a result, the inlet/outlet port 233 is blocked by the projection 241, isolating the interior of the transmission case CS from the atmosphere.

With the breather path blocked, it is possible to prevent water from entering the transmission case CS. Here, in the third embodiment, the water flow W3 comes from below. In the case of a water flow from a direction other than below, the casing 230 prevents entry of water into the transmission case CS.

When the water flow W3 from below stops, the water pressure does not act on the movable plate 240 any more, and therefore the movable plate 240 falls down due to the force of gravity from the uppermost position Y3 to the lowermost position X3. As a result, the interior of the transmission case CS is again communicated with the atmosphere via the hose 220 and the casing 230.

As described above, according to the breather device 210 of the third embodiment, it is possible to maintain the internal pressure of the transmission case CS at atmospheric pressure when the breather path is opened, and to prevent entry of water into the transmission case CS when the breather path is blocked.

The first casing 231 of the casing 230 and the portion 221 of the hose 220 on a first end side extend upward from the inlet/outlet port 233, and the volume corresponding to the head difference from the inlet/outlet port 233 to the highest position of the first casing 231 of the casing 230 and the portion 221 of the hose 220 on the first end side in the vertical direction (that is, the height H3) provides a buffer volume before water can enter the transmission case CS. As a result, even if water enters into the first casing 231 and the hose 220 from the inlet/outlet port 233, it is possible to prevent entry of the water into the transmission case CS, as long as the amount of the water does not exceed the buffer volume.

When the water flow W3 from below stops, the water having entered into the first casing 231 and the hose 220 from the inlet/outlet port 233 is discharged outside from the ventilation holes 242 of the movable plate 240 and the notches 236 of the second casing 232. Here, since the ventilation holes 242 of the movable plate 240 and the notches 236 of the second casing 232 are positioned below the inlet/outlet port 233 of the casing 230 when the breather path is opened, it is possible to immediately discharge the water having entered into the hose 220 and the casing 230 to the outside via the ventilation holes 242 and the notches 236. As a result, it is possible to prevent the water from remaining inside the hose 220 and the casing 230.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

For example, the housing to which the breather device of the invention is to be attached is not limited to the transmission case CS of an automobile. The breather device may be attached to a housing of which the interior is hermetically enclosed and in which a constant internal pressure needs to be maintained. For example, the breather device may be attached to a housing for accommodating a differential or transfer mechanism of an automobile, a housing for use in a vehicle other than an automobile, or a housing for use in other than a vehicle.

The breather path extending from the housing may be constituted of a tubular member other than a hose. The length of the hose or the like is not specifically limited. The case or the like of the breather device may be directly attached to the housing without using a hose or the like. The portion of the breather path on the first end side may extend in a direction other than vertically upward. The buffer volume described above is determined according to the length of the portion extending upward. The first end of the breather path may be open obliquely downward.

The shape, position, and so forth of a component of the valve mechanism are not limited to those described above, as long as the valve mechanism blocks the inlet/outlet port when there is water flowing toward the breather path, but that otherwise leaves the first end of the breather path open. For example, the shape of the cover 30 in the first embodiment, the shape of the casing 130 and the position of the rotary shaft 135 in the second embodiment, the shape of the casing 230 and the movable plate 240 in the third embodiment, and so forth may be other than those described above.

What is claimed is:

1. A breather device comprising:
a breather path with a first end that is open to an atmosphere and a second end that is in communication with an interior of a housing; and
a valve mechanism that blocks the first end of the breather path when the water pressure of water flowing toward the breather path acts on the valve mechanism, but that otherwise leaves the first end of the breather path open.

2. The breather device according to claim 1, wherein
the valve mechanism has an opening on its top side, and is attached to an outer periphery of a tubular member that forms the breather path so as to be movable along an extending direction of the tubular member.

3. The breather device according to claim 2, wherein
the valve mechanism has a projection on its bottom side that blocks the first end of the breather path with the projection when the mechanism is pushed by the water pressure of water flowing toward the breather path.

4. The breather device according to claim 1, wherein
the valve mechanism is coupled to a case main body that forms a part of the breather path via a rotary shaft.

5. The breather device according to claim 4, wherein
the valve mechanism has a projection on its upper side that blocks the first end of the breather path with the projection when the valve mechanism is pivoted by the water pressure of water flowing toward the breather path.

6. The breather device according to claim 1, wherein
the valve mechanism is provided inside a casing connected to a tubular member that forms the breather path and the valve mechanism is movable along an extending direction of the casing.

7. The breather device according to claim 6, wherein
the casing includes a first casing that forms a part of the breather path, and a second casing that accommodates the valve mechanism, and
a plurality of hooks are provided in a lower portion of the second casing to regulate movement of the valve mechanism.

8. The breather device according to claim 7, wherein
the valve mechanism has a projection on its top side that blocks the first end of the first casing when the valve mechanism is pushed by the water pressure of water flowing toward the breather path.

9. The breather device according to claim 1, wherein
the valve mechanism has an opening that is open to the atmosphere, the opening being positioned below the first end of the breather path.

10. The breather device according to claim 1, wherein
a portion of the breather path extends upward from the first end.

11. The breather device according to claim 10, wherein
the portion of the breather path extends vertically upward from the first end to a predetermined height.

12. The breather device according to claim 1, wherein
the housing accommodates a transmission mechanism of an automobile.

13. The breather device according to claim 1, wherein
the housing accommodates a differential mechanism of an automobile.

14. The breather device according to claim 1, wherein
the housing accommodates a transfer mechanism of an automobile.
